(19) United States
(12) Patent Application Publication
(10) Pub. No.: US 2012/0005714 A1
(43) Pub. Date: Jan. 5, 2012

(54) METHODS, SYSTEMS, AND COMPUTER PROGRAM PRODUCTS FOR CONFIGURING A CONTEXTUAL CHANNEL IDENTIFIER

(76) Inventor: Robert Paul Morris, Raleigh, NC (US)

(21) Appl. No.: 12/830,392

(22) Filed: Jul. 5, 2010

(51) Int. Cl. H04N 7/173

(52) U.S. Cl. 725/118

(57) ABSTRACT

Methods and systems are described for configuring a contextual channel identifier. Channel information is received that identifies a channel identifier in a first channel binding, in a first channel context, binding the channel identifier to a first data source. The first data source is accessible via a tuner and is accessed, when the first channel context is active and the channel identifier is selected, to receive data from the first data source to present via an output device. Context configuration information is received identifying a second channel binding that binds the channel identifier to a second data source. The second channel binding is bound to a second channel context, in response to receiving the context configuration information, so that the second data source is accessed, when the second context is active and the channel is selected, to receive data from the second data source to present via an output device.

### RELATED APPLICATIONS

This application is related to the following commonly owned U.S. Patent Applications, the entire disclosure of each being incorporated by reference herein: application Ser. No. ______, (Docket No 0146) filed on May 7, 2010, entitled “Methods, Systems, and Program Products for Configuring Access to a Data Source based on a Channel Identifier”;

Application Ser. No. ______, (Docket No 0161) filed on May 7, 2010, entitled “Methods, Systems, and Program Products for Selecting a Data Source Based on a Channel Identifier”; and

Application Ser. No. ______, (Docket No 0160) filed on May 7, 2010, entitled “Methods, Systems, and Program Products for Processing a Contextual Channel Identifier”.

### BACKGROUND

Most users are comfortable with television user interfaces based on channel identifiers. While these interfaces have been in use for decades, they have changed little from a functional perspective. New features for televisions typically are accessed through new buttons on remote controls and on the television devices themselves. This has led to a relatively large number of buttons and complex interfaces when compared with the original channel changers. Despite the expanded user interface, little in the way of features for personalization of television and/or other audio/video (A/V) nodes has been added.

Accordingly, there exists a need for methods, systems, and computer program products for configuring a contextual channel identifier.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for configuring a contextual channel identifier. In one aspect, the method includes receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device. The method further includes receiving context configuration information identifying a second channel binding that binds the first channel identifier to a second data source. The method still further includes binding, in response to receiving the context configuration information, the second channel binding to a second channel context to configure the execution environment to access the second data source, when the second channel context is active and the first channel identifier is selected, to receive data to present via an output device.

Further, a system for configuring a contextual channel identifier is described. The system includes an execution environment including an instruction processing unit configured to process an instruction included in at least one of a channel selector component, a context selector component, and a context binder component. The system includes the channel selector component configured for receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device. The system further includes the context selector component configured for receiving context configuration information identifying a second channel binding that binds the first channel identifier to a second data source. The system still further includes the context binder component configured for binding, in response to receiving the context configuration information, the second channel binding to a second channel context to configure the execution environment to access the second data source, when the second channel context is active and the first channel identifier is selected, to receive data to present via an output device.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for processing a contextual channel identifier according to an aspect of the subject matter described herein;

FIG. 3 is a block diagram illustrating an arrangement of components for processing a contextual channel identifier according to another aspect of the subject matter described herein;

FIG. 4 is a block diagram illustrating an arrangement of components for configuring a contextual channel identifier according to another aspect of the subject matter described herein;

FIG. 5 is a network diagram illustrating an exemplary system for configuring a contextual channel identifier according to an aspect of the subject matter described herein;

FIG. 6a is a diagram illustrating a user interface presented via a display according to an aspect of the subject matter described herein;

FIG. 6b is a diagram illustrating a user interface presented via a display according to another aspect of the subject matter described herein;

FIG. 7 is a flow diagram illustrating a method for configuring a contextual channel identifier according to another aspect of the subject matter described herein; and

FIG. 8 is a block diagram illustrating an arrangement of components for configuring a contextual channel identifier according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

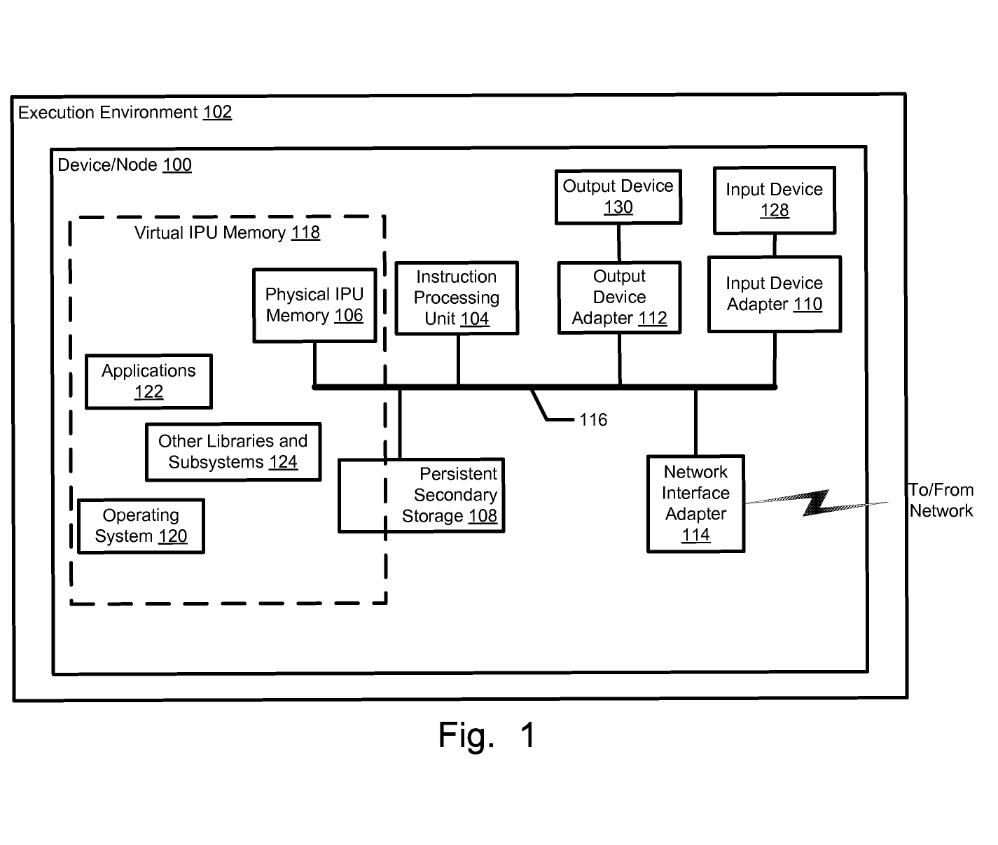

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include televisions, audio receivers, media servers, personal computers, notebook computers, tablet computers, servers, handheld and other mobile devices, multiprocessor devices, distributed devices, consumer electronic devices, routers, communication servers, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer readable storage media provide volatile and/or nonvolatile storage for computer readable instructions, data structures, program components, and/or other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “device” and “node” as used herein refer to one or more devices and nodes, respectively, providing and/or otherwise included in an execution environment unless clearly indicated otherwise.

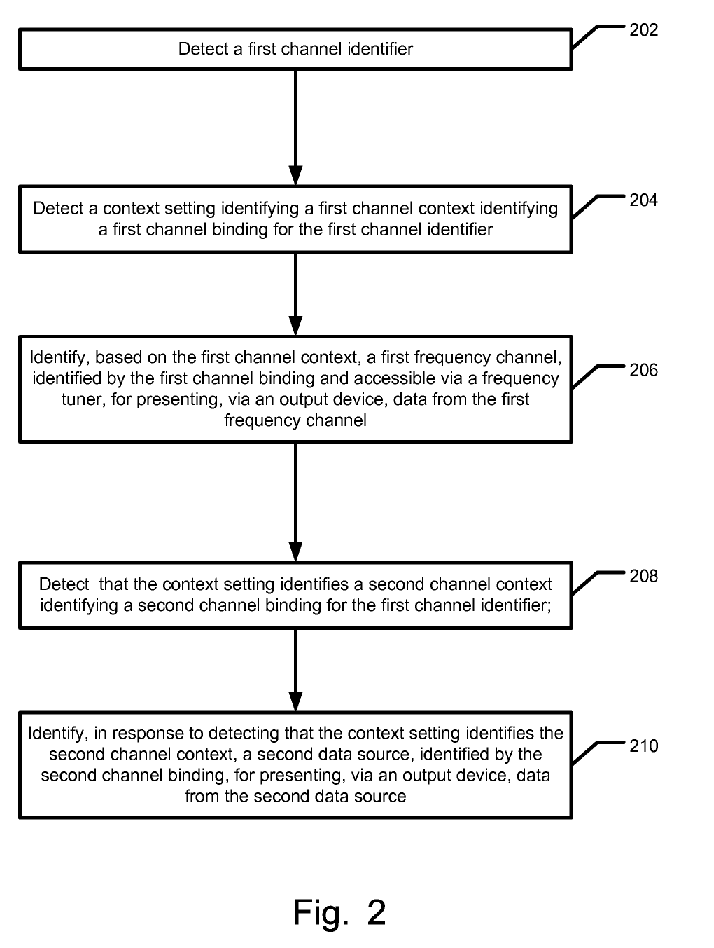

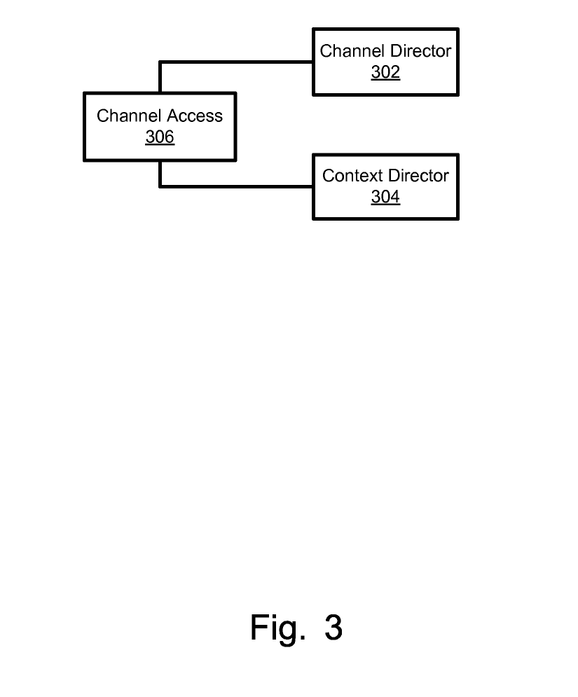

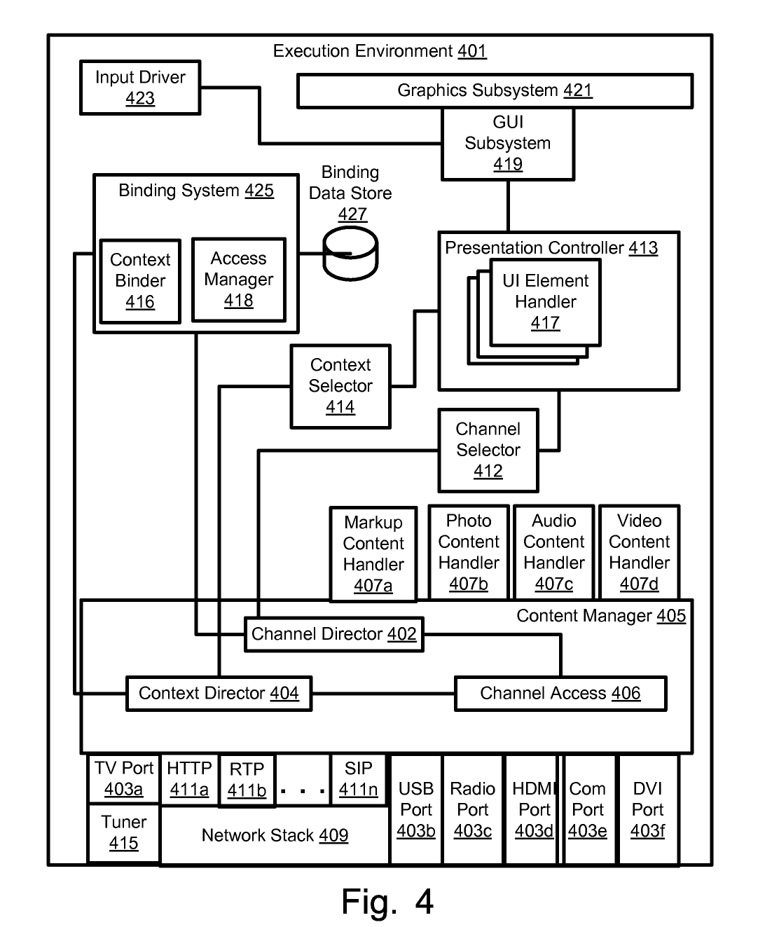

The block diagram in FIG. 3 illustrates an exemplary system for processing a contextual channel identifier according to the method illustrated in FIG. 2. A system for performing the method illustrated in FIG. 2 includes an execution environment, including an instruction-processing unit, configured to process an instruction included in at least one of a channel director component 302, a context director component 304, and a channel access component 306 illustrated in FIG. 3. Some or all of the exemplary components illustrated in FIG. 3 may be adapted for performing the method illustrated in FIG. 2 in a number of execution environments. FIG. 4 is a block diagram illustrating the components of FIG. 3 and/or analogs of the components of FIG. 3 adapted for operation in execution environment 401 including or otherwise provided by one or more nodes.

FIG. 1 illustrates components of an exemplary device that may at least partially provide and/or otherwise be included in an execution environment. The components illustrated in FIG. 4 may be included in or otherwise combined with the components of FIG. 1 to create a variety of arrangements of components according to the subject matter described herein.

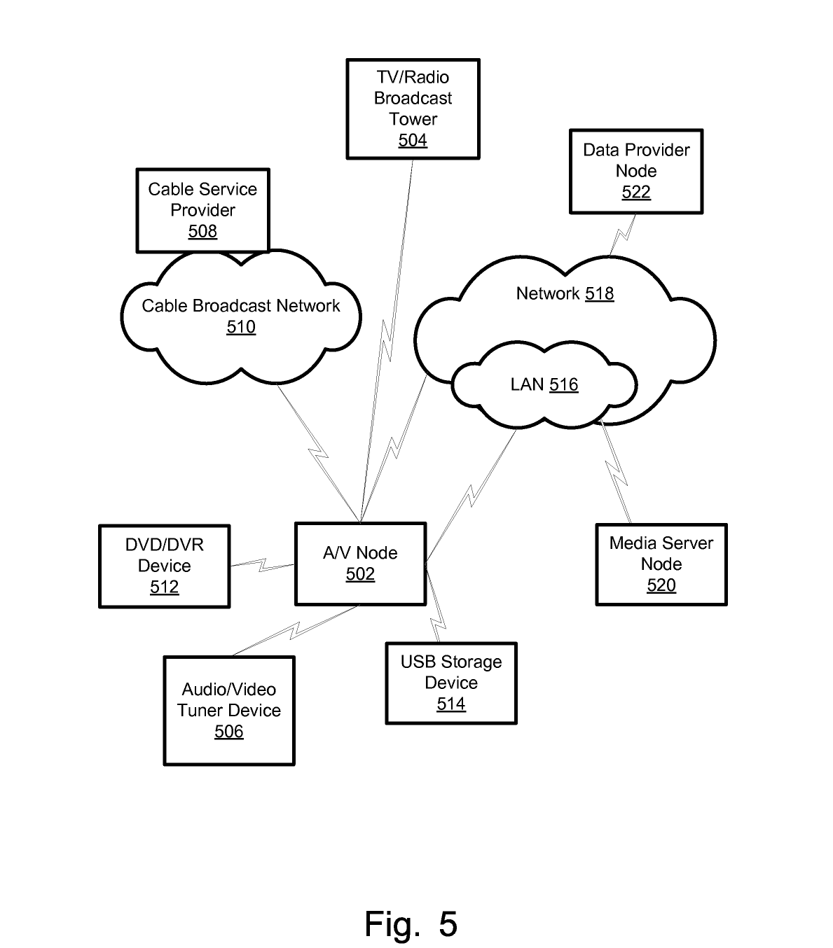

FIG. 5 illustrates audio/video (A/V) node 502 as an exemplary device or node including and/or otherwise operatively coupled to a tuner for receiving data from a frequency channel for presenting via an output device. A/V node 502 may include a television and/or a radio. A/V node 502 may be communicatively coupled to a variety of data providers. FIG. 5 illustrates that A/V node 502 may be communicatively coupled to one or more over-the-air broadcast television and/or radio stations represented by TV/radio broadcast tower 504. The television and/or radio data provider(s) may be accessed via a tuner for receiving over-the-air broadcast signals via an antenna. The tuner may be included in A/V node 502 and/or may be external to and operatively coupled to A/V node 502 as illustrated by audio/video tuner device 506. A/V node 502 may receive television and/or radio broadcast data from a cable service provider 508 via a physical coupling to cable broadcast network 510 of cable service provider 508. A/V node 502 may include a cable tuner and/or may be operatively coupled to an external cable tuner, for example, in a set-top box.

A/V node 502 may include one or more communications ports for directly connecting to a data provider. Exemplary service ports include a high-definition multimedia interface (HDMI), a digital video interface (DVI), a composite interface, and a universal serial bus (USB) port. Exemplary data providers that may be coupled to and/or included in A/V node 502 via a communications port include a digital video disc (DVD) device and/or digital video recording (DVR) device 512, a video cassette recording VCR device (not shown), a compact disc (CD) player (not shown), and/or a universal serial bus (USB) mass storage device 514.

In another aspect, A/V node 502 may be operatively coupled to one or more data sources via one or more networks, such as LAN 516 in a home or business. LAN 516 may be included in a network, such as network 518, that may include the Internet. A/V node 502 may be communicatively coupled to various data providers in the home or business, such as a media server node 520, a desktop PC, a laptop, a netbook, a smart phone, and/or a tablet computing device. A/V node 502 may be communicatively coupled to one or more Internet data providers including media content providers and document providers. Data provider node 522 illustrates an Internet data provider. A communicative coupling may be persistent, remaining even while content via the coupling is not being presented by A/V node 602 via an output device. A communicative coupling may be temporary, becoming active and remaining active while content via the coupling is being presented by A/V node 502 and/or otherwise actively processed. For example, content not being presented may be stored in a data storage media component or device such as DVD/DVR device 512 and/or USB storage device 514 for later access.

FIG. 4 illustrates exemplary execution environment 401 including and/or provided by A/V node 502. Execution environment 401 of A/V node 502 may include an arrangement of components for receiving analog signals and/or digitally modulated information transmitted over the air (wirelessly) and/or via a broadcast data network such as provided by cable television service provider 508. Digitally modulated information is transmitted according to a specified format. For example, high-definition television (HDTV) format differs from standard-definition, and digital formats differ from analog. A/V node 502 may be configured to receive and process television signals according to one or more broadcast formats. A/V node 502 may include one or more port components 403 illustrated in execution environment 401 in FIG. 4. Television signals transmitted by an over-the-air broadcaster via TV/radio broadcast tower 504 may be received via an antenna coupled to A/V node 502 via tuner component 415 and TV port 403a. TV port component 403a may alternatively or additionally receive, via broadcast network 510, signals of cable service provider 508. A/V node 502 may include one or more TV port components 403a.

A/V node 502 includes content manager component 405 in FIG. 4. Content manager component 405 may perform some preprocessing of data from one or more port components 403. For example, content manager component 405 may decompress and/or amplify digital television data received via TV port component 403a. Alternatively or additionally, for data received from at least some of port components 403, content manager component 405 may provide the data to one or more content handler components 407 based on the port(s) providing the data and/or the format(s) or content type of the data received. Content manager component 405 may include hardware and/or software. For example, content manager component 405 may include a system on a chip (SOC). Content manager component 405 may process all incoming video and audio received via one or more of TV port component 403a, USB port component 403b, radio port component 403c, HDMI port component 403d, composite input port component (com port) 403e, and DVI port component 403f, to name a few examples.

Content manager component 405 may also process data received via network 518 via a network interface component illustrated in FIG. 1, such as an Ethernet adapter. Data received via a network interface component may be processed via one or more layers of network stack 409, such as a TCP/IP stack, and optionally processed by one or more protocol layer components 411 configured to process received data according to a session, presentation, and/or application layer protocol. FIG. 4 illustrates that execution environment 401 of A/V node 502 includes HTTP component 411a for processing data according to hypertext transfer protocol (HTTP), real-time transport protocol (RTP) component 411b for various forms of streamed data, session initiation protocol (SIP) component 411n for processing data according to a session initiation protocol (SIP), and/or other protocol components (not shown).

A content handler component 407 may process data according to the data's content type to produce presentation information to send to an output device, such as a display and/or a speaker, to present to a user. For example, data from TV port 403a may be decompressed by content manager 405 in order to provide an audio portion of the data to a suitable audio content handler 407c and a video portion of the data to a video content handler 407d.

Output generated by audio content handler 407c may be routed to speakers, stereo line outs, and/or headphones. Output of video content handler component 407d may be routed to a display driver for a display device, such as an LCD screen. Content handlers 407 may include and/or retrieve decoders and encoders as required based on various types of media containers and content types. For example, MPEG-2 decoders and/or composite video encoders may be included and/or otherwise accessible to one or more content handlers 407.

If a TV port is configured to receive an analog signal, the signal may be converted by a first content handler to a digital signal for processing by one or more audio and video content handlers. Content handlers 407, in an aspect, may be operatively coupled in chains of content handlers 407 to process received data. The chains may be persistently configured or configured dynamically as needed by content manager component 405.

Received data may include synchronization information and/or metadata such as text for closed captioning. Metadata may be handled by a suitable content handler component 407. For example, metadata specified according to resource definition framework (RDF) may be processed by a content handler for processing extensible markup language (XML) formatted data. Presentation controller component 413 may receive synchronization information and process output of one or more content handler components 407 according to the synchronization information. Metadata for closed captioning may be provided to a content handler 407 based on the content type of the captioning data.

TV port 403a may include a tuner component 415 and/or may be operatively coupled to a frequency tuner, such as audio/video tuner device 506. TV port component 403a may output data at a fixed frequency and/or otherwise in a fixed format regardless of the frequency channel received by the tuner. TV port component 403a may generate output for data received via a frequency channel selected from multiple frequency channels receivable by tuner component 415 and/or A/V tuner device 506. If a user selects channel identifier “2”, the picture and audio encoded in the electromagnetic waves corresponding to channel identifier “2” may be detected by tuner component 415 and encoded by tuner component 415 and/or TV port component 403a to a standard frequency, referred to as the “intermediate frequency”, and/or other suitable encoding. The output of TV port 403a may be amplified by content manager 405, the data signal may be amplified by TV port 403a prior to providing the output to content manager component 405, and/or the data signal may be amplified by a content handler component 407.

In an aspect, once the output of TV port component 403a is large enough to be processed, audio content handler component 407c may receive sound data from the amplified intermediate frequency signal to direct to an audio output subsystem (not shown) operatively coupled to speakers, headphones, and/or other audio output devices. Interoperation between audio content handler component 407c and the audio subsystem may be direct, and/or may be mediated or otherwise directed by presentation controller 413. For a color television, video content handler component 407d may extract visual information, such as luminance and chrominance information, from the amplified intermediate frequency signal. The information is transformed into presentation information for display by a display device.

For network data providers, FIG. 4 illustrates network stack 409 in execution environment 401 for sending and receiving data over network 518 in FIG. 5 via a network interface component of A/V node 502. Network stack 409 may support a protocol suite, such as TCP/IP, or may communicate via a network gateway such as cable modem or other protocol translation device and/or service.

Execution environment 401 may be configured to browse LAN 516 and/or network 518 and/or otherwise access data provider node 522 and/or media server node 520 via universal resource identifiers (URIs) identifying resources accessible via the nodes. A/V node 502 may retrieve and host a web application agent received in one or more messages sent from a web application operating in data provider node 522, for example. Content manager component 405 may interoperate with hypertext transfer protocol (HTTP) component 411a and/or network stack 409 to receive the message or messages including some or all of the web application agent.

The web application agent may include a web page or document, and/or other presentation information for presenting content from data provider node 522. The web page may include and/or reference data represented in one or more formats including hypertext markup language (HTML) and/or other markup languages, ECMAScript or other scripting languages, byte code, image data, audio data, and/or machine code, to name just a few valid data representations depending on the capabilities of a receiving A/V node 502.

One or more messages from data provider node 522 and/or media server node 520 may include content received by content manager component 405 via HTTP component 411a and network stack 409. In FIG. 4, content manager component 405 may provide the received content to one or more content handler components 407 to process according to the data type(s) in the received content. Content types may be identified by MIME-type identifiers. Exemplary content handler components 407 for Internet content include a text/html content handler component for processing HTML representations illustrated by markup content hander component 407a; one or more video content handler components 407d described above, one or more audio content handler components 407c also described above, and still image data content handler components illustrated by photo content handler component 407b for processing various still image data representations. Content handler component(s) 407 may provide their output to one or more user interface element handler components 417.

User interface element handler components 417 are illustrated in FIG. 4 in presentation controller component 413. Presentation controller component 413 may manage visual, audio, and other types of output for execution environment 401 as well as receive and route detected user and other inputs to components and extensions of A/V node 502. With respect to FIG. 4, a user interface element handler component 417 may be adapted to operate at least partially in a content handler component 407 such as a text/html content handler component and/or a script content handler component. Additionally or alternatively, a user interface element handler component in execution environment 401 may operate in an application agent received via a communication and/or network interface component. For example, an application agent may include a retrieved HTML document.

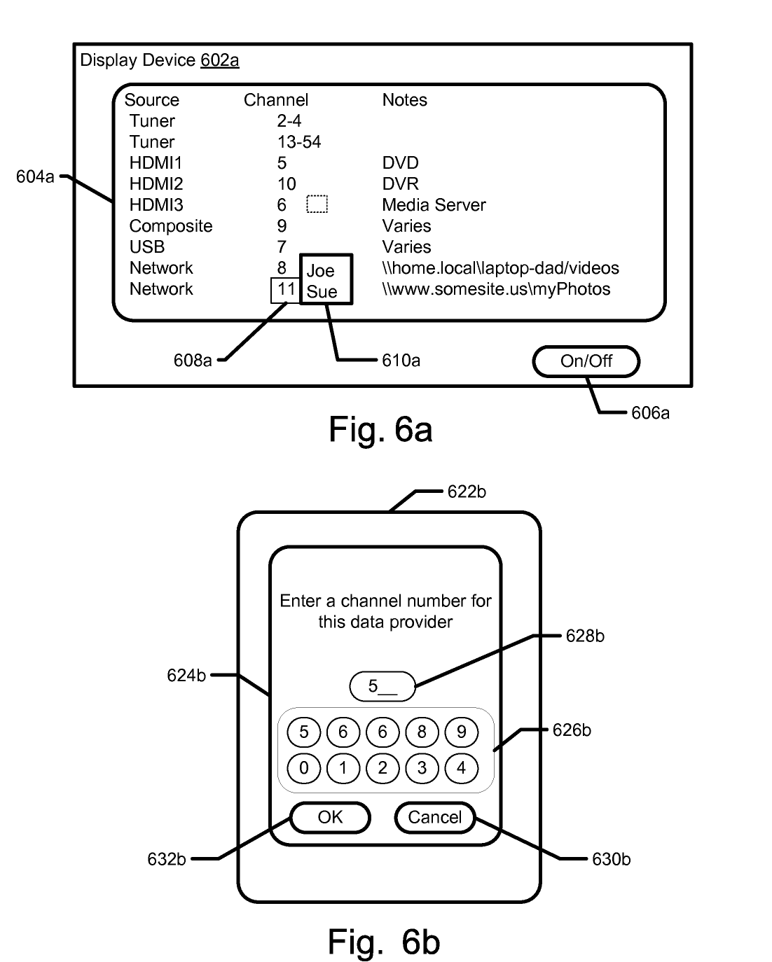

FIG. 6a illustrates a display device 602a as an exemplary output device. Display device 602a includes a presentation space 604a for presenting visual output. Display device 602a may include one or more hardware and/or software user interface controls. On/off control 606a illustrates a hardware control for turning display device 602a on and off. A display device may be included in or may be external and operatively coupled to A/V node 502 in FIG. 5. Channel selection UI element 608a illustrates a selection user interface control for selecting a channel identifier and context selection list UI element 610a illustrates a control for selecting a channel context for identifying a channel binding for the channel identifier selected via selection UI element 608a.

FIG. 6b illustrates a user interface of a handheld device UI 622b. A/V node 502, in an adaptation, may be a handheld device and execution environment 401 may include and/or otherwise be provided by a handheld device with user interface 622b. Handheld device UI 622b includes a display illustrated as presentation space 624b. Various software interface controls are illustrated including soft keypad 626b in a touch screen for entering numbers. A number selector UI element 628b presents numeric input received via soft keypad 626b. FIG. 6b also illustrates cancel soft button 630b for receiving input to cancel entering a number, and OK soft button 632b for receiving input to receive an entered number.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual component”, and “visual interface element” are used interchangeably in this document. Other types of user interface elements include audio output components referred to as audio interface elements, tactile output components referred to as tactile interface elements, and the like.

A “user interface (UI) element handler” component, as the term is used in this document, includes a component configured to send information representing a program entity for presenting a user detectable representation of the program entity by an output device, such as a display or a speaker. A “program entity” is an object included in and/or otherwise processed by an application or executable program component. The user detectable representation is presented based on the sent information. The sent information is referred to herein as “presentation information”.

Presentation information may include data in one or more formats. Exemplary formats include image formats such as JPEG, video formats such as MP4, markup language data such as HTML and other XML-based markup, and/or instructions such as those defined by various script languages, byte code, and/or machine code. For example, a web page received by a browser from a remote application provider may include HTML ECMAScript, and/or byte code for presenting one or more user interface elements included in a user interface of the remote application.

Components configured to send information representing one or more program entities for presenting particular types of output by particular types of output devices include visual interface elements, audio interface element handler components, tactile interface element handler components, and the like.

A representation of a program entity may be represented and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory, secondary storage, a memory of an output device adapter device, and/or a storage medium of an output device. A screen of a display, for example, is a presentation space.

As used herein, the terms “program”, “program component”, “application”, “code library”, and “executable” refer to data representations that may include and/or may be translated into a set of machine code instructions and optionally associated program data. Thus, a program or executable may include a shared library, a non-shared library, and/or a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which the term “object code” is used will make clear the state of the object code when it is relevant. This definition can include machine code and virtual machine code, such as JAVA™ byte code.

As used herein, an “addressable entity” is a portion of a program specifiable in a source code language, which is addressable within a compatible execution environment. Examples of addressable entities include variables, constants, functions, subroutines, methods, classes, anonymous scoped instruction sets, and labeled instructions. Strictly speaking, the addressable entity contains a value or an instruction, but it is not the value or the instruction. In some places, this document will use “addressable entity” in a manner that refers to the content or value of an addressable entity. In these cases, the context will clearly indicate the intended meaning.

Addressable entities may have a number of corresponding representations. These representations include source code, object code, and any intermediate formats used by an interpreter, compiler, linker, loader, or analogous tool. Thus, terms such as “addressable source code entity” may be used in cases where the format or type of representation is relevant.

In an aspect, various user interface elements of A/V node 502 may be presented by one or more user interface element handler components 417. User interface element handler component(s) 417 in FIG. 4 may send presentation information representing a visual interface element(s), such as cancel button 630b illustrated in FIG. 6b, to GUI subsystem 419. GUI subsystem 419 may instruct graphics subsystem 421 to draw the visual interface element(s) in a region of display presentation space 604a in FIG. 6a and/or presentation space 624b in FIG. 6b, based on the presentation information.

Input may be received via input driver 423 in FIG. 4. For example, a user may touch a location in presentation space 624b in FIG. 6b that includes a UI element identifying an operation, such as cancel button 630b. Input driver 423 may detect the touch and the location. The detected input may be received by GUI subsystem 419 via input driver 423 as an operation or command indicator based on the association of the shared location of the touch and cancel button 630b in presentation space 624b.

A “channel context” as used herein includes and/or otherwise identifies zero or more channel bindings. A channel context is identifiable via a channel context identifier. A “channel binding” includes and/or otherwise identifies a channel identifier and a data source. When a first channel context is active, channel bindings in the active channel context are active. When a second channel context is activated in place of the first channel context, a second set of channel bindings may be activated in place of and/or instead of channel bindings in the first channel context.

In an aspect, multiple channel contexts may be simultaneously active. They may include and/or identify channel bindings that don't share channel identifiers, a channel context may be configured to have precedence over another channel context, and/or data from different data sources may be presented at the same time such as via different output devices. A channel context with higher precedence hides or deactivates one or more channel bindings in a lower precedent channel context that has shared channel identifier(s) between the channel contexts.

A channel context including a set of channel bindings may be identified by a channel context identifier. A channel context identifier may be any suitable identifier such as user name, a location identifier, and/or a number. A television may include one or more predefined channel contexts, such as contexts for sports, news, movies, and the like. Alternatively or additionally, a channel context identifier may be defined by information received from a user. Channel bindings in a channel context may be predefined and/or assigned to a channel context by a user.

With reference to FIG. 2, block 202 illustrates that the method includes detecting a first channel identifier. Accordingly, a system for processing a contextual channel identifier includes means for detecting a first channel identifier. For example, as illustrated in FIG. 3, channel director component 302 is configured for detecting a first channel identifier. FIG. 4 illustrates channel director component 402 as an adaptation and/or analog of channel director component 302 in FIG. 3. One or more channel director components 402 operate in execution environment 401.

Channel information may identify a particular channel by a number or other identifier. A channel identifier differs from a channel of a frequency tuner, such as a television tuner and/or a radio tuner. A channel for a tuner, also referred to herein as a frequency channel, includes a frequency range detectable to the tuner for producing output data for presenting via one or more output devices. A particular frequency channel may be identified by a channel identifier, such as channel “3”. A channel identifier may be detected in response to user input identifying the channel identifier. For example, a user may identify a particular channel identifier via software and/or hardware keys associated with numbers. Television remote controls and keypads are exemplary input devices for receiving specific channel identifiers in response to user input. Numeric keypad 626b in FIG. 6b is an exemplary user interface for detecting a channel identifier in response to user input.

In another aspect, detecting a channel identifier may include receiving channel information that identifies a channel identifier relative to another channel identifier. For example, an active channel setting variable associated with a storage location in an execution environment may identify a first channel identifier as an active channel selection. Directional user interface controls, such as up and down buttons on a television remote control device, may be included in receiving user input for detecting a selection of a second channel identifier relative to the first channel identifier identified by the active channel setting. The second channel identifier may be determined based on an ordering of the channel identifiers. For numbered channels the second channel identifier may be a next channel identifier numerically higher or lower than the first channel identifier identified by the active channel setting.

Channel information, identifying a channel identifier, may be received in response to input detected by input driver 423. In one aspect, input driver 423 may provide input information to GUI subsystem 419. GUI subsystem 419 may determine a location in a presentation space, such as presentation space 604a in FIG. 6a, corresponding to the input. A location may be determined based on the current location of a pointer icon or a detected touch on a touch screen. GUI subsystem 419 may determine a UI element presented in the location and provide the input data to an application component, such as UI element handler component 417 presenting the UI element. The UI element handler 417 may be directed by channel selector component 412. In response to the detected input, channel selector component 412 may provide channel information to channel director component 402 to detect the channel identifier identified by the channel information.

In another aspect, input driver 423 may include and/or otherwise interoperate with a hardware component that in response to a detected input provides channel information for a particular channel identifier. Alternatively, input driver 423 may include and/or otherwise interoperate with a hardware component that in response to a detected input provides channel information for detecting a channel identifier relative to another channel identifier, such as the channel identifier in the active channel setting described above.

Whether channel selector component 412 is included in one or more applications operable in an A/V node and/or is included as a system component, a channel selector component 412 may determine whether a detected input is for changing an active channel setting or whether the input is for configuring a channel context. When channel information is received for changing the active channel setting and/or otherwise for accessing a data source to present data from the data source via an output device, channel information may be provided to channel director component 402 to detect a channel identifier based on the channel information.

Channel director component 402 may determine whether channel information is received for configuring a channel context or not. In an aspect, channel director component 402 may access a mode setting (not shown) in execution environment 401. Channel director component 402 may determine that received channel information is for accessing a data source to present to a user when the mode setting is set to a presentation or play mode. Channel information may be received for configuring a channel context when the mode setting is in a configuration mode. In an aspect, channel information may be received for configuring a channel context and for changing an active channel in the process of configuring the channel context.

The channel identified by the received channel information may identify a frequency channel of a tuner via a channel binding identifying the channel identifier and the frequency channel as a data source. In an aspect, the default data source bound to a channel identifier may a frequency channel of a tuner, such as tuner component 415.

A channel identifier for a data source currently being accessed may be detected by checking the active channel setting. The active channel setting may be included in and/or otherwise accessible to channel director component 402 from a storage location in and/or otherwise accessible to execution environment 401.

Returning to FIG. 2, block 204 illustrates that the method further includes detecting a context setting identifying a first channel context identifying a first channel binding for the first channel identifier. Accordingly, a system for processing a contextual channel identifier includes means for detecting a context setting identifying a first channel context identifying a first channel binding for the first channel identifier. For example, as illustrated in FIG. 3, context director component 304 is configured for detecting a context setting identifying a first channel context identifying a first channel binding for the first channel identifier. FIG. 4 illustrates context director component 404 as an adaptation and/or analog of context director component 304 in FIG. 3. One or more context director components 404 operate in execution environment 401.

Context information may identify a particular channel context for determining a channel binding for a channel identifier. Which data source a channel identifier is bound to depends on a channel context in which the channel identifier is interpreted. For example, personalized channel identifiers may be supported by A/V node 502 by defining multiple user channel contexts.

A user may identify and/or activate a particular channel context via software and/or hardware keys. As with channel identifiers, television remote controls and keypads are exemplary input devices for receiving specific channel context identifiers in response to user input. As with channel identifiers, a channel context identifier may be identified relative to another channel context identifier. For example, an active context setting may identify a first channel context identifier as a current active channel context. Directional user interface controls such as up and down buttons on a television remote control device may detect user input for detecting a selection of a second channel context identifier relative to the first channel context identifier identified by the active context setting. The second channel context identifier may be determined based on an ordering of the channel context identifiers.

Context information identifying a selected channel context identifier may be detected by input driver 423. In one aspect, input driver 423 may provide input information to GUI subsystem 419. GUI subsystem 419 may determine a location in a presentation space, such as presentation space 604a in FIG. 6a or presentation space 624b in FIG. 6b, corresponding to the input. A location may be determined based on the current location of a pointer icon or a detected touch on a touch screen. For example, a first input may be received corresponding to channel selection UI element 608a to present channel context selection UI element 610a. A user input may be received for a first channel context identified by “Joe” or an input may be received for a second channel context identified by “Sue” via context selection UI element 610a in FIG. 6a. A data source bound to a channel depends on a channel context in which the binding is included. GUI subsystem 419 may determine a UI element presented in the location and provide the input data to an application component, such as UI element handler component 417. The UI element handler 417 may be directed by context selector component 414. In response to the detected input, context selector component 414 may provide context information to context director component 404 to detect the selection of the channel context identifier identified by the context information.

In another aspect, input driver 423 may include and/or otherwise interoperate with a hardware component that in response to a detected input provides context information for a particular channel context identifier. Alternatively, input driver 423 may include and/or otherwise interoperate with a hardware component that in response to a detected input provides context information for detecting a selected channel context identifier relative to another channel context identifier, such as a channel context identifier stored and/or referenced in the active context setting described above. Context information may be received by context director 404 from an input driver 423.

Context director component 404 may determine whether a detected input is for changing an active channel context or whether the input is for configuring a channel context. When context information is received for changing the active context setting and/or otherwise for configuring a channel context identified by the context information, context information may be provided to context director component 404 to detect a channel context identifier identified by the context information.

Channel director component 404 may determine whether context information is received for changing the active context setting or for configuring the identified channel context. In an aspect described above, context director component 404 may access a mode setting (not shown) in execution environment 401. Context director component 404 may determine that received context information is for changing the current set of active channel bindings in a play or presentation mode. Context information may be received for configuring a channel context when the mode setting is in a configuration mode. In an aspect, context information may be received for configuration and for changing an active channel context when the mode setting is set to a configuration mode.

Detecting a channel context to determine a corresponding set of channel bindings may include checking the active context setting. The active context setting may be included in and/or otherwise accessible to context director component 404.

Returning to FIG. 2, block 206 illustrates that the method further includes identifying, based on the first channel context, a first frequency channel, identified by the first channel binding and accessible via a frequency tuner, for presenting, via an output device, data from the first frequency channel. Accordingly, a system for processing a contextual channel identifier includes means for identifying, based on the first channel context, a first frequency channel, identified by the first channel binding and accessible via a frequency tuner, for presenting, via an output device, data from the first frequency channel. For example, as illustrated in FIG. 3, channel access component 306 is configured for identifying, based on the first channel context, a first frequency channel, identified by the first channel binding and accessible via a frequency tuner, for presenting, via an output device, data from the first frequency channel. FIG. 4 illustrates channel access component 406 as an adaptation and/or analog of channel access component 306 in FIG. 3. One or more channel access components 406 operate in execution environment 401.

In an aspect, channel access component 406 may be invoked by content manager component 405 to receive access information identifying a data source currently being accessed. Data from the data source is presented as described above via one or more content handlers 407 based on one or more content types of some or all of the data. Content manager component 405 may determine that the access information is bound to the channel identifier in the active channel setting maintained by channel director component 402. Content manager component 405 may further determine that the channel identifier is in a channel context identified by the active context setting maintained by context director component 404.

In another aspect, content manager component 405 may receive, from channel director component 402, channel information detected via channel selector component 412 and/or via an input driver component 423. Content manager component 405 may additionally receive context setting information from context director component 404 as detected via context selector component 414 and/or via an input driver component 423.

Content manager component 405 may identify the channel context and the channel identifier to binding system 425. A channel binding may be located based on the context information and channel information received by content manager component 405. Binding system 425 may maintain and/or otherwise have access to channel bindings and channel context bindings. A channel context binding identifies channel bindings and identifies a channel context that includes the channel bindings. A channel binding and/or a channel context binding may be stored in a local data store in execution environment 401. Alternatively, binding system 425 may be configured to interoperate with network stack 409 to access a channel binding and/or a channel context binding via network 518 from another node, such as media server node 520, a node including a configuration service such as a DHCP service, and/or a node including a data store such as a directory service.

Binding system 425 may locate a channel context binding based on the channel context identifier provided by content manager component 405. Binding system 425 may locate a channel binding identified by the channel context binding based on the channel identifier received from content manager component 405. Binding system 425 may provide access information identified by the located channel binding to content manager component 405. Content manager component 405 may provide the access information to channel access component 406 to identify the data source to access data to present via an output device as described above. The access information and data source are identified by the detected channel identifier based on the identified channel context.

Returning to FIG. 2, block 208 illustrates that the method further includes detecting that the context setting identifies a second channel context identifying a second channel binding for the first channel identifier. Accordingly, a system for processing a contextual channel identifier includes means for detecting that the context setting identifies a second channel context identifying a second channel binding for the first channel identifier. For example, as illustrated in FIG. 3, context director component 304 is configured for detecting that the context setting identifies a second channel context identifying a second channel binding for the first channel identifier.

Context director component 404 may detect that the active context setting identifies a second channel context different from a previously detected first channel context. Context director component 404 may detect a change in the active context setting. In another aspect, context director 404 may modify the active context setting in detecting the change. Detecting an active context setting by context director component 404 is described above.

An indication to change the active context setting may be received in response to an event other than a user input. For example, an active context setting change may be configured in a schedule. At a specified time, a specified channel context may be configured to become the active channel context. Context director component 404 may detect time-based events and access scheduled channel context change configuration data. Event-based channel context change configuration data may be predefined, defined by a user, received via a removable data storage device, and/or received via a network. In an aspect, channel context change configuration data may be maintained by a node other than A/V node 502. For example, media server node 520 may maintain channel context change configuration data. A/V node 502 may receive notifications instructing context director component 404 and/or content manager component 405 to change the active context setting.

In response to detecting the changed channel context identified by a second channel context identifier, context director component 404 may notify content manager component 405 of the changed channel context. Content manager component 405 may identify the channel identifier for accessing a data source to present data via an output device. The channel identifier may be included in the previously active first channel context. In the previously active first channel context, the channel identifier is included in a channel binding identifying the first data source.

As described above, content manager component 405 may identify the second channel context and the first channel identifier to binding system 425. Binding system 425 may locate a second channel context binding based on the second channel context identifier provided by content manager component 405. Binding system 425 may locate a second channel binding identified by the second channel context binding based on the first channel identifier received from content manager component 405. Binding system 425 may provide second access information, identified by the located second channel binding, to content manager component 405. Content manager component 405 may provide the second access information to channel access component 406. The data source may be a second data source different from the first data source. The data source may be a data source other than tuner component 415 as described in application Ser. No. ______, (Docket No 0146) filed on May 5, 2010, entitled “Methods, Systems, and Program Products for Configuring Access to a Data Source based on a Channel Identifier” and in application Ser. No. ______, (Docket No 0161) filed on May 5, 2010, entitled “Methods, Systems, and Program Products for Selecting a Data Source Based on a Channel Identifier”.

Returning to FIG. 2, block 210 illustrates that the method further includes identifying, in response to detecting that the context setting identifies the second channel context, a second data source, identified by the second channel binding, for presenting, via an output device, data from the second data source. Accordingly, a system for processing a contextual channel identifier includes means for identifying, in response to detecting that the context setting identifies the second channel context, a second data source, identified by the second channel binding, for presenting, via an output device, data from the second data source. For example, as illustrated in FIG. 3, channel access component 306 is configured for identifying, in response to detecting that the context setting identifies the second channel context, a second data source, identified by the second channel binding, for presenting, via an output device, data from the second data source.

Channel access component 406 may receive and/or otherwise identify data from the second data source, based on the second access information, to present in a second presentation via an output device of execution environment 401.

In an aspect, a channel binding may not exist for a particular channel context. When a channel binding is not determined and/or otherwise not located in an active channel context, binding system 425 may provide an indicator to channel director component 402 that the data source for the channel identifier is accessible via TV port 403a. Binding system component 425 may identify TV port component 403a indicating that a frequency channel accessible via tuner component 415 that corresponds to the first channel identifier is the second data source in the second channel context. Alternatively, binding system component 425 may return an error when no binding is located. Channel director component 402, in response, may process the first identifier in the second channel context as a frequency channel identifier by default.

When a channel binding in the active channel context is located, the access information bound to the channel identifier may be retrieved by binding system component 425 and returned to channel director component 402 for changing the current data source.

In an aspect, access information identified by a located channel binding may identify a frequency channel of tuner component 415. The frequency range identified by the access information may differ from a frequency range normally associated with the channel identifier. Channel director component 402 and/or channel access component 406 may map the channel identifier of the bound frequency channel identified in the access information to an identifier recognizable by tuner component 415 as corresponding to the frequency channel bound to the channel information by the channel binding. Channel access component 406 may provide channel mapping information to TV port component 403a to access the frequency channel identified by the access information in the located channel binding.

In another aspect, access information in the located channel binding may identify an HDMI, DVI, composite, and/or other port communicatively coupled to DVD/DVR device 512. Channel director component 402 may identify the port component 403 identified in the access information to channel access component 406. Channel access component 406 may configure content manager 405 to receive data from the identified port 403 to access data from DVD/DVR device 512. Thus, a user may watch data provided by DVD/DVR device 512 by selecting a configured channel identifier, such as channel number “12”.

In yet another aspect, a channel identifier may be bound in a particular channel context to access information for accessing a data source via a data provider accessible via network 518, as illustrated by data provider node 522 and/or media server node 520. For example, the identified access information may include and/or otherwise identify a universal resource identifier (URI), such as a universal resource locator (URL). A URL may identify a protocol based on a URL scheme, such as HTTP, RTP, and/or SIP. The data accessed may be static data such as an image and/or may include dynamic data such as a media stream. The data may be interactive or non-interactive.

Channel director component 402 may change the active channel setting to identify the second channel identifier. Channel director component 402 may instruct content manager component 405 to halt processing data from the data source bound to the active channel identifier in the previous channel context and/or may instruct a data provider and/or communications port to halt providing data to content manager component 405 for processing.

The method illustrated in FIG. 2 may include additional aspects supported by various adaptations and/or analogs of the arrangement of components in FIG. 3. As described above, in an aspect, execution environment 401 may include an active channel setting for storing information identifying an active channel identifier. A channel identifier may be detected in response to an event for storing information identifying the channel identifier in the active channel setting. The event may be a user input, a message received via a network, a timer, a specified duration of time, a particular time, and/or a state of a frequency channel.

With respect to a state of a frequency channel, a frequency channel may have varying signal strength. A/V node 502 may be a mobile device. A change in accessibility of the frequency channel corresponding to a change in signal strength may cause an event to be generated by tuner component 415. In response to the event, channel director component 402 may identify a channel identifier bound to the frequency channel and/or may access the active channel setting to determine whether to bind the frequency channel to the channel identifier in response to an increase in signal strength and/or to otherwise modify a binding based on a change in the signal strength.

An active context setting may be stored in a location in a data storage medium, such as a processor memory in execution environment 401. Detecting a change in the active context setting from a first channel context to a second channel context may include accessing data stored in the location by, for example context selector component 414 and/or context director component 404. The change may be detected by accessing the location multiple times to detect the change in channel context.

Alternatively, detecting a change in the active context setting may include detecting a user input and/or other event defined for changing the active context setting. Exemplary events that may be defined for changing the active context setting include a message received via a network, a timer, a specified duration of time, a user, a content rating of data received from a data source, geospatial information, a state of a data source, access to a removable data storage device, a user, and a measure of quality of data from a data source.

Accessing a data source may include accessing data from the active channel setting to determine the active channel identifier and accessing the active context setting to identify the active channel context. A channel binding may be located and/or otherwise accessed based on the channel context and the channel identifier. A data source identified by access information in the channel binding and/or identified by the channel binding is accessed to receive data to present via an output device. Channel identifiers are bound to data sources based on a channel context. Thus in a first channel context a first channel identifier, second channel identifier, and so on may identify different data sources depending on the channel context in which they are processed. With two channel contexts, two channel identifiers may identify, for example, four data sources.

Detecting that an active context setting identifies a different channel context may include receiving a change channel context indicator for changing the active context setting to identify the second channel context. Context director component 404 may be configured to receive a change channel context indicator. The active context setting may be modified to identify the different context information. Changing a channel context may be performed in correspondence with presenting the data from a different data source due to a different channel binding identified by a channel identifier due to the change in channel context. For example, a second channel context for setting the active context setting may be identified based on a user input detected, by context selector component 414, corresponding to at least one of a numeric input control and an input control corresponding to a direction to navigate according to an order of a first channel context identifier for the first channel context and a second channel context identifier for the second channel context. The numeric input control may include a hardware control for receiving a number as input from a user. An active context setting may be identified based on at least one of a user, a group, a device, a location, a time, and a task.

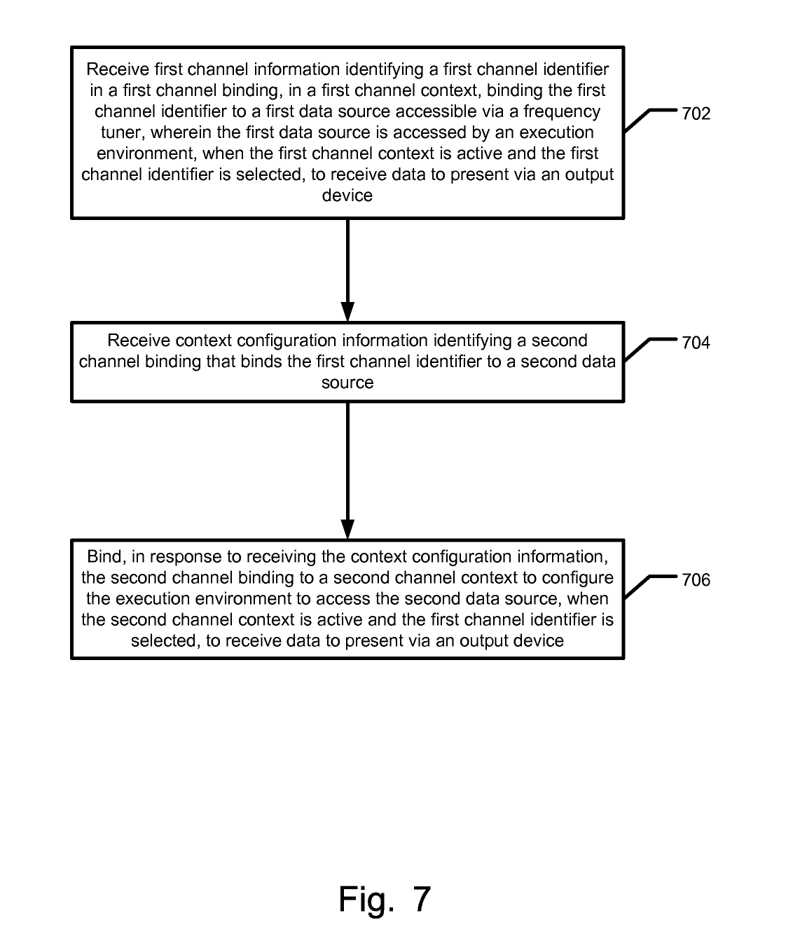

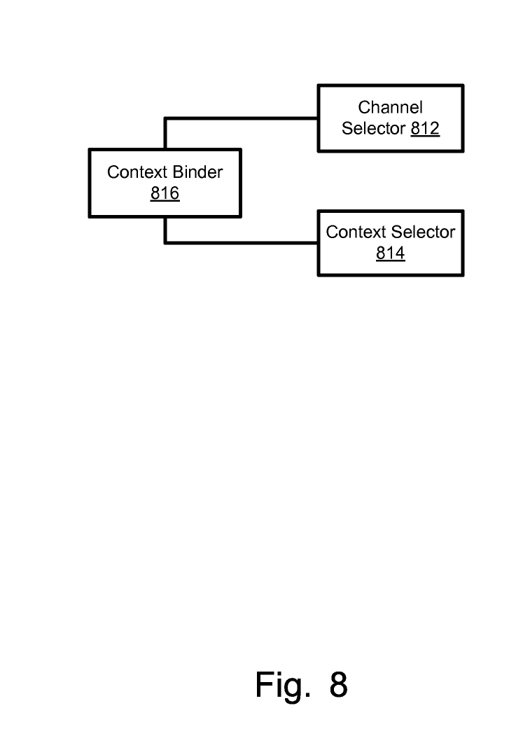

The block diagram in FIG. 8 illustrates an exemplary system for configuring a contextual channel identifier according to the method illustrated in FIG. 7. A system for performing the method illustrated in FIG. 8 includes an execution environment, including an instruction-processing unit, configured to process an instruction included in at least one of a channel selector component 812, a context selector component 814, and a context binder component 816 illustrated in FIG. 8. Some or all of the exemplary components illustrated in FIG. 8 may be adapted for performing the method illustrated in FIG. 7 in a number of execution environments. FIG. 4 is a block diagram illustrating the components of FIG. 8 and/or analogs of the components of FIG. 8 adapted for operation in execution environment 401 including or otherwise provided by one or more nodes.

With reference to FIG. 7, block 702 illustrates that the method includes receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device. Accordingly, a system for configuring a contextual channel identifier includes means for receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device. For example, as illustrated in FIG. 8, channel selector component 812 is configured for receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device. FIG. 4 illustrates channel selector component 412 as an adaptation and/or analog of channel selector component 812 in FIG. 8. One or more channel selector components 412 operate in execution environment 401.

Returning to FIG. 7, block 704 illustrates that the method further includes receiving context configuration information identifying a second channel binding that binds the first channel identifier to a second data source. Accordingly, a system for configuring a contextual channel identifier includes means for receiving context configuration information identifying a second channel binding that binds the first channel identifier to a second data source. For example, as illustrated in FIG. 8, context selector component 814 is configured for receiving context configuration information identifying a second channel binding that binds the first channel identifier to a second data source. FIG. 4 illustrates context selector component 414 as an adaptation and/or analog of context selector component 814 in FIG. 8. One or more context selector components 414 operate in execution environment 401.

As described above, a user may identify a particular channel identifier via software and/or hardware keys associated with numbers. Context configuration information may include a channel identifier identified by a user. Television remote controls and keypads are exemplary input devices for receiving specific channel identifiers in response to user input.

Channel identifiers may be included in and/or otherwise associated with a channel context identified by a channel context identifier. A channel context identifies one or more channel bindings. A channel binding identifies a channel identifier and identifies a data source to access when the channel binding is selected and active. A channel binding is selected when its channel identifier is selected. A channel binding is active when a channel context including and/or otherwise identifying the channel binding is active in a device and/or node for presenting data from the data source.

For example, a first user of A/V node 502 may configure a first channel context including a first channel identifier bound to a first data source. A second user of A/V node 502 may configure a second channel context including the first channel identifier bound to a second data source different from the first data source. A channel context may be associated and/or identified based on a user, a time, a content type, a content rating, and/or any other suitable classification for grouping channel bindings.

Receiving and/or otherwise detecting channel identifiers and context information identifying a channel context is described above and not repeated here. Channel information and/or context information may be respectively received by channel selector component 412 and/or context selector component 414 for including in and/or otherwise associating a channel binding with a channel context.

Channel selector component 412 and/or context selector component 414 may determine whether a detected input is for changing an active channel and/or channel context or whether the input is for configuring a channel context. When context configuration information is received for configuring an identified channel context, channel selector component 412 and/or context selector component 414 may provide channel information and/or context information to context binder component 416. Channel selector component 412 and context selector component 414 may interoperate directly and/or may interoperate indirectly as illustrated in FIG. 4 via content manager component 405 and binding system 425.

Channel selector component 412 and/or context selector component 414 may determine whether channel information and/or context information is received for configuring a channel context by checking a mode setting (not shown) in execution environment 401. Channel selector component 412 and/or context selector component 414 may determine that received channel information and/or context information is for configuring the channel context when the mode setting is set to a configuration mode. In an aspect, channel information and/or context information may be received for configuring a channel context and for changing a current data source when the mode setting is set to a configuration mode allowing a user to view a data source included in configuring a channel context.

A channel identified by the received channel information may identify a frequency channel of a tuner. In an aspect, the default data source bound to a channel identifier may be a frequency channel of a tuner, such as tuner component 415. In another aspect, a channel identifier may identify any of various other types of data and/or data sources.

Context configuration data may identify a pre-existing channel binding. Context configuration information may identify a data source and a channel binding may be created identifying the channel identifier identified in received channel information and identifying the data source. Context configuration may identify an existing channel context accessible by context director component 404 via binding system 425 for configuring. Context configuration may included and/or identify an indicator for creating a new context. Context director component 404 may receive a channel context identifier via context selector component 414 based on user input. Context director component 404 may interoperate with context binder component 416 to allocate a new channel context identified by the received identifier in binding data store 427.

Returning to FIG. 7, block 706 illustrates that the method yet further includes binding, in response to receiving the context configuration information, the second channel binding to a second channel context to configure the execution environment to access the second data source, when the second channel context is active and the first channel identifier is selected, to receive data to present via an output device. Accordingly, a system for configuring a contextual channel identifier includes means for binding, in response to receiving the context configuration information, the second channel binding to a second channel context to configure the execution environment to access the second data source, when the second channel context is active and the first channel identifier is selected, to receive data to present via an output device. For example, as illustrated in FIG. 8, context binder component 816 is configured for binding, in response to receiving the context configuration information, the second channel binding to a second channel context to configure the execution environment to access the second data source, when the second channel context is active and the first channel identifier is selected, to receive data to present via an output device. FIG. 4 illustrate context binder component 416 as an adaptation and/or analog of context binder component 816 in FIG. 8. One or more context binder components 816 operate in execution environment 401.

Channel information received by channel selector component 412 and context information received by context selector component 414 may be received by and/or otherwise identified to context binder component 416. Context binder component 416 in FIG. 4 is illustrated as a component of binding system 425 along with access manager component 418 providing access to channel context bindings identifying one or more channel bindings stored in binding data store 427.

In one aspect, a channel context record identifying a channel context may be stored in binding data store 427. Context binder component 416 may create a channel context binding by updating the channel context record to identify a channel binding. A channel context record may include and/or otherwise identify one or more channel bindings.

In FIG. 4, the first channel binding may be accessed via a request to access manager component 418 where the request identifies the first channel context and identifies the first channel identifier. Access manager component 418 may locate and/or otherwise retrieve information from the first channel binding from a data store, illustrated by binding data store 427 in FIG. 4. The first channel binding may be located based on the first channel context and the first channel identifier. Data associating the first channel context and first channel identifier with the first channel binding may be stored in a data store in execution environment 401 as just described. Alternatively or additionally, channel context binding information may be stored in a data store of another node such as media server node 520, and/or may be in a removable data storage media device for personalizing channels on A/V node 502 and/or for storing channel context bindings for accessing in another A/V node and/or tuner-based system.

Context binder component 416 may interoperate with access manager component 418 to store channel context bindings as channel context binding information representing channel context records, channel binding records, access information records, and/or data analogs of channel context records, channel binding records, and/or access information records in binding data store 427 and/or another data storage system and/or data storage device.

Channel context bindings created by context binder component 416 may be accessible to other components of execution environment 401 and/or other A/V nodes via binding data store 427, via other data storage devices and systems, and via network 506 for identifying and accessing a data source bound to a channel identifier.

The method illustrated in FIG. 7 may include additional aspects supported by various adaptations and/or analogs of the arrangement of components in FIG. 8. For example, channel information and/or context information for binding a channel binding to a channel context may be received in response to detecting an input and/or otherwise receiving information identifying a channel identifier available for binding. A numeric input control may include a hardware control for receiving a number as input from a user. A hardware control may include a numeric keypad and a navigation input control. The hardware control may be communicatively coupled to a node operatively coupled to a tuner, such as A/V node 502, and may be included in at least one of a remote control device, a keyboard, and a touch screen.

Channel information may identify a channel binding of a channel identifier based on another channel identifier. Context information may identify a first channel context based on another channel context. For example, first channel information may be received by channel selector component 412 in FIG. 4, in response to receiving an input indicating a direction to navigate from a second channel identifier in an ordered arrangement of channel identifiers. The second channel identifier may be included in and/or otherwise identified by an active channel setting. Channel director component 402 may include and/or otherwise access the active channel setting. First context information may be received by context selector component 414 in FIG. 4, in response to receiving an input indicating a direction to navigate from a second channel context identifier for a second channel context in an ordered arrangement of channel identifiers. The second channel context identifier may be included in and/or otherwise identified by the active context setting. Context director component 404 may include and/or otherwise access the active context setting.

A representation of a channel identifier of a channel binding and/or a channel context identifier of a channel context may be presented via an output device. The representation of the channel identifier and/or the representation of the channel context identifier may be, respectively, presented along with representations of one or more other channel identifiers and/or channel context identifiers available for binding. Channel selector component 412 and/or context selector component 414 may interoperate with presentation controller component 413 and/or one or more UI element handler components 417 to present the representations. Presentation controller component 413 and/or one or more UI element handler components 417 may receive selection information identifying a particular channel identifier and/or channel context identifier in response to a detected input that corresponds to a presented representation of the particular channel identifier and/or the particular channel context identifier. Channel selector component 412 and/or context selector component 414 may select the particular channel identifier and/or the particular channel context identifier, respectively, in response to the input.

As described above, creating and/or modifying a channel context binding may be performed automatically. Also as described above, creating and/or modifying a channel context binding may be performed in response to a user input and/or other event indicating that a channel context binding should be created and/or updated. For example, an indication to modify a binding may be generated based on a timer. A/V node 502 may access data from a data source in a channel binding to present via an output device. Binding system 425 may determine that the channel binding is not bound to a channel context identified by an active context setting. A timer may be set by binding system 425. If the timer expires while the data source is still being accessed, binding system 425 may automatically bind the channel binding to the identified channel context, in one aspect. In another aspect, binding system 425 may invoke context selector component 414 to receive context information to determine a channel context to modify based on the channel binding. An event indicating that a channel binding should be assigned to a channel context based on a count of accesses to a channel binding. The event may alternatively or additionally be based on a duration of time.

Still further, a channel context binding may include and/or otherwise identify a time when a channel context and/or one or more channel bindings in the channel context may be active. Geospatial information may be included in and/or otherwise associated with channel context binding information for determining a geospatial region where a channel context and/or one or more channel bindings in the channel context may be active.

A channel context binding may be stored in any suitable data store. Exemplary data stores media include a processor memory, a persistent data store, a removable data store, and/or a network accessible data store. Alternatively or additionally, a channel context binding may be stored by sending channel context binding information via a network to a channel context node. The stored channel context binding may be accessible to other nodes for identifying channel bindings for a channel context. A channel context binding may be stored in a removable data storage device. The removable data storage device may be operatively coupled to another node to identify a channel binding based on the channel context binding stored in the removable data storage device.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); and optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for configuring a contextual channel identifier, the method comprising:
receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device;
receiving context configuration information identifying a second channel binding that binds the first channel identifier to a second data source; and
binding, in response to receiving the context configuration information, the second channel binding to a second channel context to configure the execution environment to access the second data source, when the second channel context is active and the first channel identifier is selected, to receive data to present via an output device.

2. A system for configuring a contextual channel identifier, the system comprising:
an execution environment including an instruction-processing unit configured to process an instruction included in at least one of a channel selector component, a context selector component, and a context binder component;
the channel selector component configured for receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device;
the context selector component configured for receiving context configuration information identifying a second channel binding that binds the first channel identifier to a second data source; and
the context binder component configured for binding, in response to receiving the context configuration information, the second channel binding to a second channel context to configure the execution environment to access the second data source, when the second channel context is active and the first channel identifier is selected, to receive data to present via an output device.

3. A computer-readable medium embodying a computer program, executable by a machine, for processing a contextual channel identifier, the computer program comprising executable instructions for:
receiving first channel information identifying a first channel identifier in a first channel binding, in a first channel context, binding the first channel identifier to a first data source accessible via a frequency tuner, wherein the first data source is accessed by an execution environment, when the first channel context is active and the first channel identifier is selected, to receive data to present via an output device;
receiving context configuration information identifying a second channel binding that binds the first channel identifier to a second data source; and
binding, in response to receiving the context configuration information, the second channel binding to a second channel context to configure the execution environment to access the second data source, when the second channel context is active and the first channel identifier is selected, to receive data to present via an output device.
